(19) United States
(12) Patent Application Publication
(10) Pub. No.: US 2011/0100548 A1
(43) Pub. Date: May 5, 2011

(54) Functionally Doped Polycrystalline Ceramic Laser Materials

(76) Inventors: Leslie Brandon Shaw, Woodbridge, VA (US); Jasbinder S. Sanghera, Ashburn, VA (US); Guillermo R. Villalobos, Springfield, VA (US); Woohong Kim, Lorton, VA (US); Ishwar D. Aggarwal, Fairfax Station, VA (US)

(21) Appl. No.: 12/609,324

(22) Filed: Oct. 30, 2009

(51) Int. Cl. B29C 65/02; B29C 65/00

(52) U.S. Cl. 156/308.2; 156/60

(57) ABSTRACT

A functionally doped polycrystalline ceramic laser medium and method of making thereof are provided. The medium includes a solid state polycrystalline Ytterbium doped Yttria or Scandia (Yb:Y₂O₃ or Yb:Sc₂O₃) laser medium with a discrete or continuous gradient doping profile and methods for manufacturing the same. The doping profile can be two- or three-dimensional and can vary depending upon the laser geometry, the pumping scheme, and the benefits to be desired from the laser medium's structure. The grading direction can be linear, axial, radial, or any combination thereof. The material can be made from a combination of doped and undoped solid shapes, loose powders, and green shapes, and can be diffusion bonded or densified to a desired final shape using techniques such as pressureless sintering, hot pressing, hot forging, spark plasma sintering, and hot isostatic pressing (HIPing), or their combinations.

### TECHNICAL FIELD

The present invention relates to doped polycrystalline ceramic laser materials and methods for making the same.

### BACKGROUND

A laser is a device that emits light (electromagnetic radiation) through a process called stimulated emission. Laser light is usually spatially coherent, which means that the light either is emitted in a narrow, low-divergence beam, or can be converted into one with the help of optical components such as lenses. More generally, coherent light typically means the source produces light waves that are in step. They have the same frequencies and identical phase. The coherence of typical laser emission is a distinctive characteristic of lasers. Most other light sources emit incoherent light, which has a phase that varies randomly with time and position. Typically, lasers are thought of as emitting light with a narrow wavelength spectrum (“monochromatic” light). This is not true of all lasers, however: some emit light with a broad spectrum, while others emit light at multiple distinct wavelengths simultaneously. The word laser originated as an acronym for Light Amplification by Stimulated Emission of Radiation. The word light in this phrase is used in the broader sense, referring to electromagnetic radiation of any frequency, not just that in the visible spectrum. Hence there are infrared lasers, ultraviolet lasers, X-ray lasers, etc. Three typical laser geometries, rod, disc, and slab and two pumping geometries, end and side pumping, are recognized.

Modern ceramics have recently been developed for use a laser materials. Most ceramic materials are formed from fine powders, yielding a fine grained polycrystalline microstructure which is filled with scattering centers comparable to the wavelength of visible light, or even larger. Thus, they are generally opaque materials, as opposed to transparent materials, due to the presence of porosity and impurities at the grain boundaries. Recent nanoscale technology has, however, made possible the production of polycrystalline transparent ceramics. These can be used for numerous applications including high energy lasers, transparent armor windows, and nose cones for heat seeking missiles, Additionally, when doped with rare earth ions (Nd, Pr, Er, Tm, Tb, Ho, Dy, Yb, etc) or transition metal ions (V, Cr, Cu, etc) it is possible to make transparent ceramic laser materials which can generate laser light upon suitable pumping, similar to solid state crystal lasers.

In solid state lasers, the gain medium (laser material) is usually a doped single crystal. Polycrystalline laser gain media also can be doped to improve laser performance.

Pumping a doped laser gain medium (such as Yb-doped yttria) results in laser emission, general heating of the entire laser material, and high localized heating at the pump end of the laser material. Heat management is a critical issue in the design of high energy lasers. Heat is a function of both the energy pumped into the laser material and the dopant level of the laser material; the dopant absorbs the pump energy and releases it as photons (laser) and phonons (heat). As the pump energy and/or the dopant concentration are increased, both laser emission and heat generation are increased. Localized heating is a result of the uniform dopant concentrations traditionally used in laser materials. The pump energy decreases as it travels through the laser material because it is being absorbed by the dopant.

In uniformly doped laser materials, the material near the pump end receives the most energy and produces the most heat, resulting in localized heating. Even adding a pure (0% doping) layer before the laser material, does not greatly reduce the localized heating of the gain media because the pump laser energy is not attenuated in the un-doped region. The decrease is due to the higher thermal conduction of the undoped region. But an even greater improvement can be achieved if the doping level were tailored to match the pump energy, then uniform heating and uniform laser emission can be obtained throughout the laser material. This eliminates spikes in heat and results in a uniform heating profile that enables potentially higher output power.

Ideal lasers operate with a spatial mode profile of TEM₀₀, which is a Gaussian shaped beam profile. Typically, however, the gain profile of the laser media does not match the laser beam spatial profile. The gain medium may have a uniform pump profile. In other cases, the edges may be pumped more than the center, resulting in higher gain at the edges. To ensure TEM₀₀ output in lasers, apertures are usually placed in the resonator to result in high losses for higher order modes. Unfortunately, this technique is not conducive to high power operation. Mode selectivity can be improved if the gain can be tailored to match the desired spatial mode profile of the laser. For TEM₀₀ mode, for example, the desired gain profile would be a Gaussian along the path of the laser beam.

To create a gain profile matching the spatial profile of the laser beam in rare earth doped lasers, it is desirable that the laser media be doped with a non-uniform rare earth (or transition metal ion) dopant distribution. For example, in a rod-shaped geometry, a radial distribution of the dopant profile, with the dopant concentration being highest in the center of the rod and tapering to the sides of the rod, would be desired. By tailoring the dopant profiles longitudinally and transverse to the pump, the gain profile of the laser can be made to match the TEM₀₀ profile, resulting in improved beam quality at higher powers.

Single crystal laser gain materials are formed using a variety of high temperature growth techniques from the melt, such as Bridgeman-Stockbarger and Czochralski techniques known in the art. However, due to the mechanisms of growth, it is extremely difficult to produce many single crystals with dopant levels much higher than 2% or with a smoothly graded or stepped doping profile and nearly impossible to make with a radially doped gradient or with a doping scheme that incorporates both longitudinal and radial gradients. Single crystal laser materials are therefore uniformly doped, that is, the concentration of the dopant is the same throughout the entire laser material.

It is much easier to produce graded and/or stepped doping profiles in polycrystalline gain media, and such media have been shown to accommodate greater amounts of doping than single crystals. However, due to scattering and other grain-dependent effects, such materials have had limits on the permissible grain size of the crystals. See U.S. Pat. No. 6,825,144 to Hideki (polycrystalline laser gain media are limited to crystals having a mean grain size of less than 20 μm, and laser quality ceramic cannot be made if the grains are larger).

Polycrystalline ceramic lasers have also been fabricated with un-doped regions that act as heat sinks for the doped portions of the laser gain medium and allow operation of the laser at higher energies. See U.S. Pat. No. 6,650,670 to Shimoji (describing a laser gain medium with a uniform doping of 2% coupled with an undoped layer).

In addition, segmented profiles with different dopant levels to reduce thermal stress and strain in the crystal laser rods have been proposed, see U.S. Pat. No. 5,321,711 to Rappaport, but the fabrication of these segmented profiles is difficult.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention includes a solid state polycrystalline Ytterbium doped Yttria or Scandia (Yb:Y₂O₃ or Yb:Sc₂O₃) laser material with a discrete or continuous gradient doping profile and methods for manufacturing the same. The doping profile can be two- or three-dimensional and can vary depending upon the laser geometry, the pumping scheme, and the benefits to be desired from the laser material's structure, such as thermal management, reduction of parasitic effects, mode matching, or combination of these. The grading direction can be linear, axial, radial, or any combination thereof depending on the pumping and cooling configurations. The material can be made from a combination of doped and undoped solid shapes, loose powders, and green shapes, and can be diffusion bonded or densified to a desired final shape using techniques such as pressureless sintering, hot pressing, hot forging, spark plasma sintering, hot isostatic pressing (HIPing), and combinations thereof. It is further understood that the dopant is not limited to Yb, but can be selected from the rare earth ion group consisting of Nd, Pr, Er, Ho, Tm, Tb, Dy, Yb, and their mixtures, as well as the transition metal ion group consisting of Ti, V, Mn, Cr, Fe, Cu, Zn, and their mixtures.

### BRIEF DESCRIPTION OF THE DRAWINGS

FIG. 1 depicts a plot illustrating aspects of thermal management associated with a functionally doped ceramic laser material having a graded doping profile in accordance with the present invention.

FIG. 2 depicts an exemplary Yb-doped polycrystalline ceramic laser rod having discrete doped and undoped regions in accordance with one or more aspects of the present invention.

FIG. 3 depicts an exemplary Yb-doped polycrystalline ceramic laser rod having a continuous doping gradient in accordance with one or more aspects of the present invention.

FIGS. 4A to 4D depict exemplary doping profiles of a functionally doped ceramic laser material in accordance with one or more aspects of the present invention.

FIGS. 5A to 5E depict aspects of gradient-doped transparent ceramic materials in accordance with one or more aspects of the present invention.

FIGS. 6A and 6B depict aspects of an exemplary gradient-doped rod-shaped ceramic laser material in accordance with the present invention.

FIGS. 7A and 7B depict aspects of an exemplary gradient-doped disk-shaped ceramic laser material in accordance with the present invention.

FIGS. 8A and 8B depict aspects of an exemplary radially gradient-doped rod-shaped ceramic laser material in accordance with the present invention.

FIGS. 9A and 9B depict aspects of exemplary Yb-doped ceramic laser materials having a stepped doping profile.

FIGS. 10A to 10C depict aspects of exemplary Yb-doped ceramic laser materials having a stepped doping profile and methods for manufacturing the same from doped crystalline powders in accordance with the present invention.

FIGS. 11A to 11C depict aspects of methods for fabricating a linearly graded doped laser material in accordance with the present invention.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

For example, although the invention is often described herein in the context of a Ytterbium doped Yttria (Yb:Y₂O₃) material, many of the aspects described herein can be applied to any polycrystalline ceramic laser material having a functionally gradient doping profile. In addition, although the description and the Figures herein often are directed to a doped material having dopant concentrations of 0% Yb, 1% Yb, and 2% Yb, it would be understood by one skilled in the art that a functionally doped ceramic laser material in accordance with the present invention can include more or fewer different dopant concentrations, and that the dopant concentrations are not limited to those described herein but can be any suitable level to achieve the desired performance. It is further understood that the dopant is not limited to Yb, but can be selected from the rare earth ion group consisting of Nd, Pr, Er, Ho, Tm, Tb, Dy, Yb, and their mixtures, as well as the transition metal ion group consisting of Ti, V, Mn, Cr, Fe, Cu, Zn, and their mixtures.

The present invention includes a solid state polycrystalline Ytterbium doped Yttria or Scandia (Yb:Y₂O₃ or Yb:Sc₂O₃) laser medium having a functionally gradient doping profile and methods for manufacturing the same. In accordance with the present invention, the doping profile of the laser medium can vary depending upon the laser geometry and pumping scheme and the desired benefits to be derived from the medium, such as thermal management, reduction of parasitic effects, mode matching, or combination of these. The grading direction can be two- or three-dimensional, and can be linear, axial, radial, or any combination thereof depending on the pumping and cooling configurations. A doped laser medium in accordance with the present invention can include both continuously graded laser medium and medium having a stepped doping profile comprising discrete areas having different doping levels.

Polycrystalline laser materials with graded dopant profiles allow a new degree of control over the thermal gradients and parasitic processes which occur in the high power laser media.

For example, in a first configuration, a laser having a uniform highly doped rod-shaped gain medium is end pumped. Pumping the laser media results in high population inversion near the pump input face and lower population inversion at the end of the rod. The highly pumped region experiences upconversion which reduces gain in the media and results in excess heating of the laser rod. In a second configuration, a rod having the same dimensions and average dopant concentration as the uniformly doped rod but with a functionally graded dopant profile in accordance with the present invention is used. Because the dopant profile is lower near the pump entrance and higher near the end, a uniform population inversion along the rod occurs, and lower upconversion is achieved.

By tailoring the dopant profiles longitudinally and transverse to the pump and laser emission directions, thermal gradients and parasitic processes can be minimized allowing operation of the laser at high powers with improved efficiency and beam quality. These graded profiles can result in any one or more of the following improvements in laser performance:
uniform pump absorption and gain longitudinally along the laser beam direction, resulting in uniform longitudinal thermal gradients and less localized parasitic processes such as excited state absorption (ESA) and upconversion;
uniform thermal gradients transverse to the beam direction, resulting in less transverse beam distortion;
nonuniform gain transverse to the beam direction which matches the fundamental mode of the laser beam, maintaining beam quality and allowing gain guiding
removal of spontaneous emission not contributing to the laser mode from the laser media, resulting in less amplified spontaneous emission (ASE) and parasitic lasing which can deplete gain in the fundamental laser mode; and
reduced thermal gradients at laser media endface, resulting in less stress at the endfaces and consequently increased power output and lower probability of laser damage.

A functionally doped laser medium as described herein can be made from a combination of doped and undoped solid shapes, loose powders, and green shapes, and can be diffusion bonded or densified to a desired final shape using techniques such as pressureless sintering, hot pressing, hot forging, spark plasma sintering, hot isostatic pressing (HIPing), and combinations thereof. A doped polycrystalline laser medium produced in accordance with the present invention can have a grain size larger than 20 μm.

These materials and methods for making them will be described in more detail below.

As used herein, the terms “laser medium,” “laser material,” and “gain medium” are used variously to describe a graded ceramic laser material in accordance with the present invention. The terms “graded material” or “graded ceramic material” or “graded ceramic laser material” refer to both functionally graded and stepped doped ceramic laser gain media containing more than one dopant concentration (not including the undoped region). The term “solid shape” refers to undoped, uniformly doped, and graded material that has been fully densified. “Loose powder” refers to free-flowing particles. “Green shapes” refers to loose powders that have been formed into porous green bodies having densities less than 70% of the fully densified solid ceramic material by use of techniques including but not limited to dry pressing, casting, gel casting, cold isostatic pressure (CIP), doctor blading and extrusion. The loose powders and green shapes may or may not have any combination of binders, plasticizers, wetting agents, dispersants, or any other agent that are added to improve formability and/or handling. Loose powders can be made up of any combination of nano- and micron-sized single crystal or polycrystalline particles. The individual particles can be solid or porous, can be agglomerates or aggregates of particles, or can be any combination thereof.

In accordance with the present invention, the shape and type of doping profile in a laser medium comprising a functionally doped polycrystalline ceramic material can be tailored to address specific laser performance aspects.

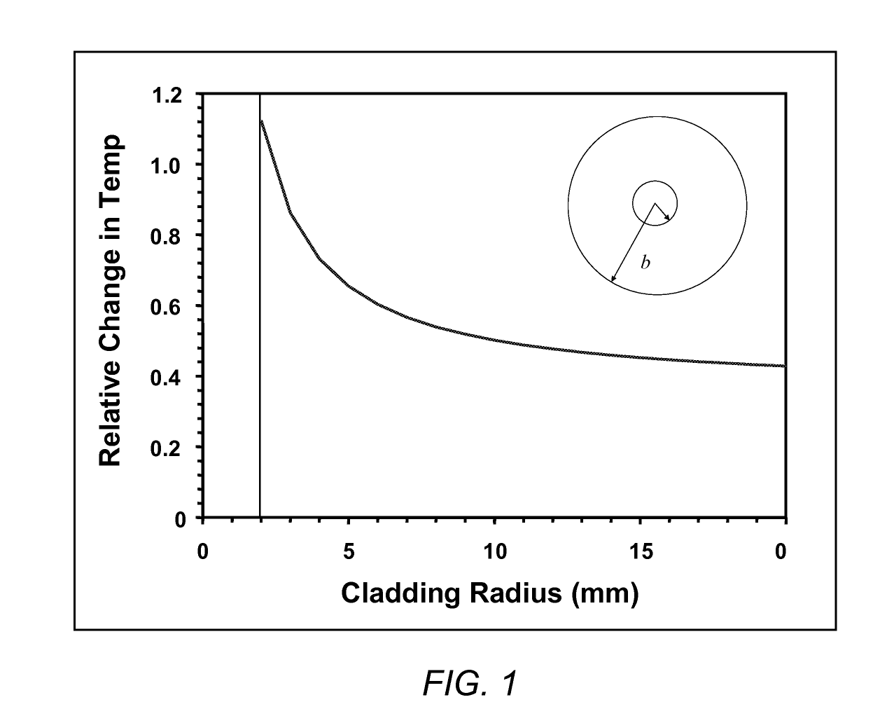

For example, for thermal management, the doping profile, convoluted with the pump absorption of the material, can result in a uniform population inversion and gain profile either transversely or radially along the rod, disk, or slab to provide increased heat dissipation and reduced thermal gradients in the material. In the exemplary embodiment shown in FIG. 1, a disk-shaped laser medium has a central Yb:Y₂O₃ doped portion having a radius a=1.5 mm, surrounded by an undoped cladding region of radius b. A plot of relative change in temperature as a function of the cladding radius b shown in FIG. 1 illustrates that temperature at the surface of central doped section, “a”, of the laser medium drops by greater than a factor of 2 (i.e., from about 1.1 to 0.5 as the cladding radius goes from 0 to 10 mm), resulting in lower thermal gradients.

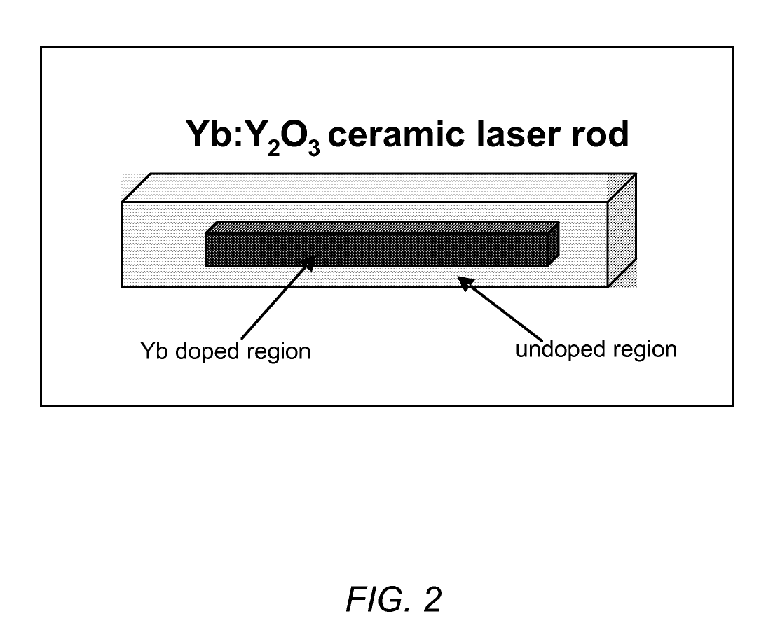

Spontaneous emission can also impair laser performance. Spontaneous emission is sometimes called fluorescence. This fluorescence can get trapped in the laser medium by reflections from side walls, especially from the air-laser ceramic interface due to the large refractive index contrast. This trapped fluorescence can be amplified leading to amplified spontaneous emission (ASE) and cause parasitic lasing which can deplete gain in the fundamental laser mode. For example, in Yb:Y₂O₃ ceramics, the index of refraction of the material is quite large (˜1.8-1.9), which leads to high reflection at the air-laser ceramic interface. This can lead to trapped fluorescence and amplified spontaneous emission. However, decreasing the concentration of the dopant reduces the refractive index of the ceramic, and so placing a lower-doped or undoped ceramic region around a higher doped ceramic region will lower reflectivity at the ceramic-ceramic interface compared with an air-ceramic boundary and so will effectively remove spontaneous emission from the active region. An exemplary embodiment of such a laser material is illustrated in FIG. 2, which shows a Yb:Y₂O₃ ceramic laser rod having a discrete Yb-doped region encapsulated by an undoped region. In this case, the undoped ceramic interface reduces the refractive index contrast at the interface between the two regions compared with just having an air interface around the doped ceramic. This effectively reduces the fluorescence trapping and therefore reduces amplified spontaneous emission and depletion of gain from the laser.

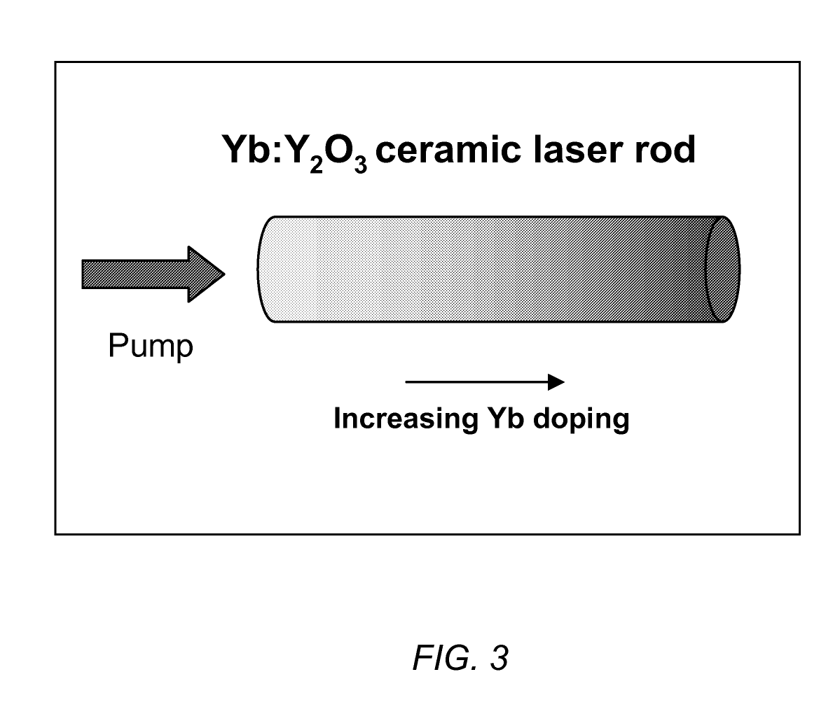

If reduction of the upconversion and ESA effects described above is desired, a functionally doped polycrystalline laser material in accordance with the present invention can be constructed to provide uniform pump absorption along the pump direction. For an end-pumped geometry with a uniformly doped rod, there is more power absorbed at the pump input end than at the output end, hence, the excited state population is higher. In the exemplary embodiment shown in FIG. 3, the dopant concentration in the medium can increase in the direction of the pump light, so that the pump power absorbed per unit length is constant, providing a uniform population inversion along the length of the material. Also, for upconversion and ESA, there is typically an optimal value for inversion which minimizes the process with respect to gain. By equalizing the inversion along the length of the rod to this optimal value, gain can be maximized relative to the parasitic process. A laser medium having a composite structure with an increasing dopant profile enables this optimized inversion for a given pump.

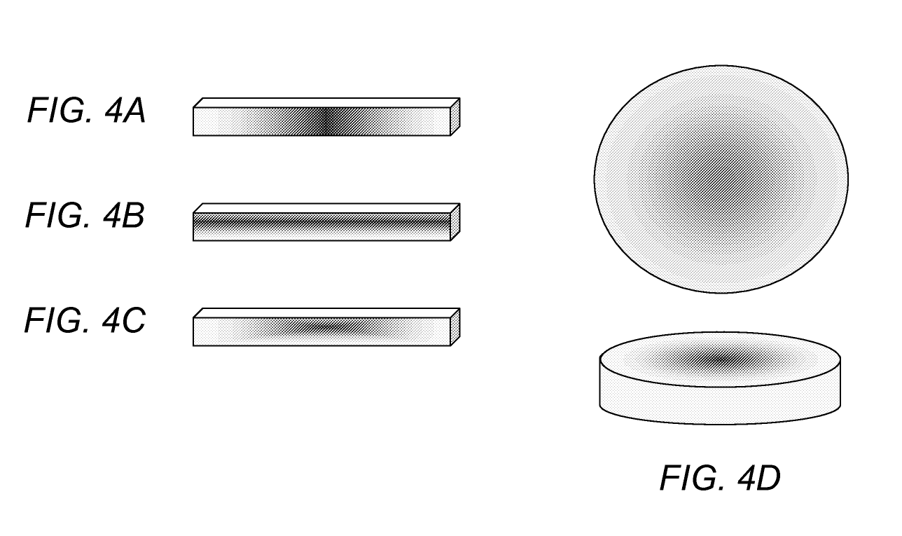

In general, the doping profiles of a functionally doped polycrystalline Yb:Y₂O₃ or Yb:Sc₂O₃ laser medium in accordance with the present invention can include those shown in FIGS. 4A to 4D. It should be noted that although FIGS. 4A to 4D depict embodiments having continuously graded doping levels, the doping profiles illustrated in these figures can also be applied in embodiments having discrete or stepped doping levels, and all such embodiments are within the scope of the present disclosure.

FIG. 4A depicts a rod-shaped laser medium having a longitudinal doping profile along the direction of the propagating laser beam, with the center of the rod having a high dopant concentration, which is gradually reduced to zero or near zero at the ends. The cross-section shown here is square, but could be rectangular, circular or some other solid cross-section. FIG. 4D shows a similar doping profile applied to a disk-shaped laser medium, with the doping level decreasing radially from a high level at the center to lower levels at the edges of the disk. As described above, a doping profile as shown in FIGS. 4A and 4D can provide a combination of uniform thermal gradients, resulting in less beam distortion and nonuniform gain transverse to the beam direction which matches the fundamental mode of the laser beam, maintaining beam quality and allowing gain guiding.

FIG. 4B depicts a laser medium having a radial doping profile. That is, the material is uniformly doped along its length, with the concentration varying, in this case decreasing, radially around the central high doped region. Such a profile can be used in rod and disk lasers to provide a combination of uniform thermal gradients, resulting in less beam distortion as well as nonuniform gain transverse to the beam direction which matches the fundamental mode of the laser beam, maintaining beam quality and allowing gain guiding.

In addition, as shown in FIG. 4C, the doping profile of a laser material in accordance with the present invention can be a combination of both a longitudinal and a radial profile, with the dopant level decreasing along in both the longitudinal and radial directions from the center of the rod. A laser material having such a doping profile can provide a combination of uniform thermal gradients, resulting in less beam distortion as well as nonuniform gain transverse to the beam direction which matches the fundamental mode of the laser beam, maintaining beam quality and allowing gain guiding.

Embodiments of doped polycrystalline ceramic laser materials having one or more features in accordance with the present disclosure can be further illustrated by the following Examples 1-4.

### Example 1

### Transparent Three- or Five-Layer Ceramic

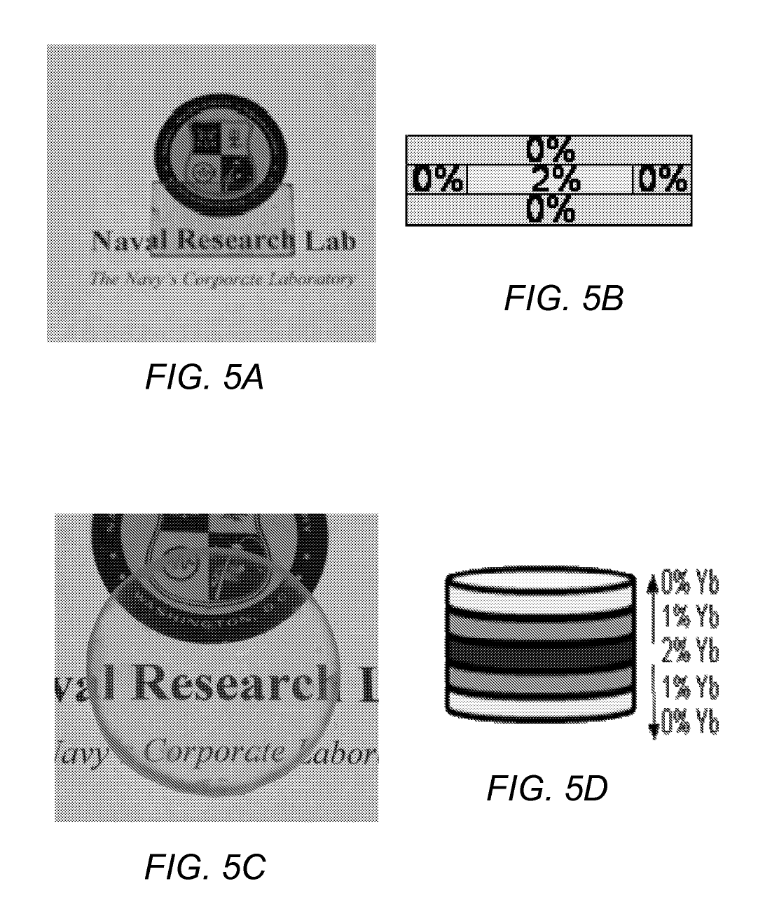

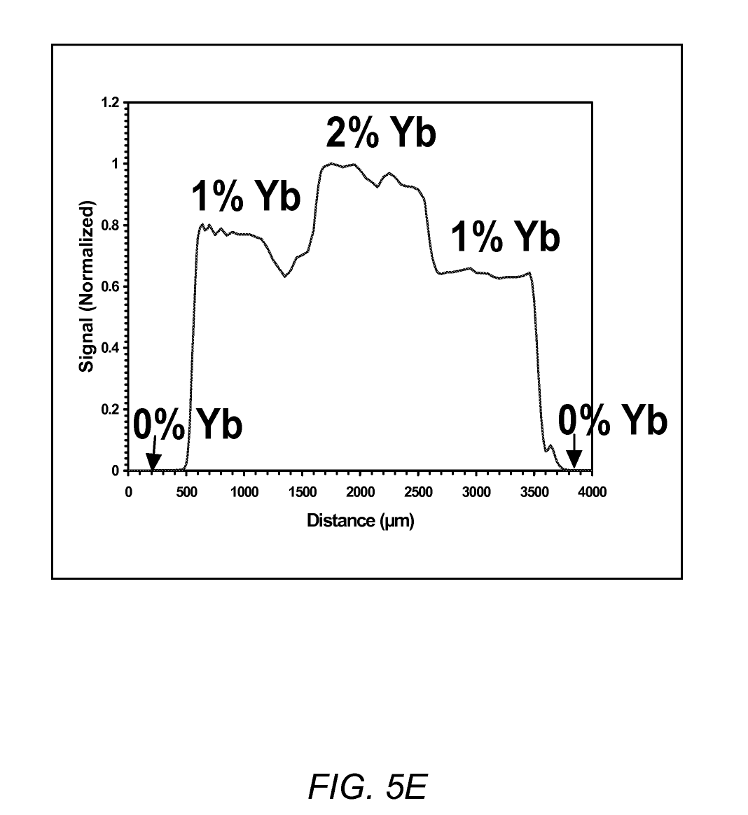

FIGS. 5A-5E depict aspects of exemplary embodiments of a doped Yb:Y₂O₃ transparent ceramic laser material in accordance with the present invention FIG. 5A depicts an exemplary three-layer doped Yb:Y₂O₃ transparent ceramic laser material which comprises a 2% Yb-doped layer encapsulated by undoped material, as seen in the cross-section depicted in FIG. 5B. FIG. 5C depicts a five-layer material having a cross section as shown in FIG. 5D, comprising an inner layer consisting of 2% Yb-doped Y₂O₃ which is surrounded on either side by 1% Yb-doped Y₂O₃, with the doped layers encapsulated with undoped Y₂O₃. This configuration is suitable for pumping from both end faces. The dopant profile of the material shown in FIG. 5C is clearly seen in the plot of green upconversion fluorescence shown in FIG. 5E. Since Yb exhibits green upconversion fluorescence on pumping, then this can be used to probe the location of Yb in material. In this case, the sample in FIG. 5C was fractured in half to expose the cross-section through the material. The sample was then pumped at 940 nm laser using a 5 μm spot size and the green upconversion fluorescence detected. This then provides spatial disposition of the Yb in the material and its concentration through the cross-section, as shown in FIG. 5E. The doped material in these embodiments has a grain size greater than 20 μm, typically in the range of 50-100 μm, which prior art has indicated should not be capable of lasing

### Example 2

### Yb:Y₂O₃ Laser Rod

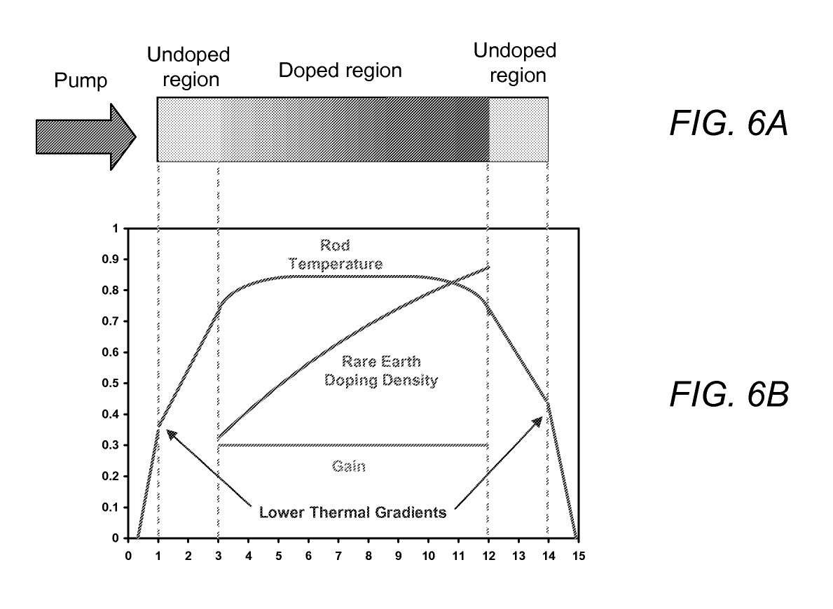

In this exemplary embodiment, illustrated in FIGS. 6A and 6B, a Yb:Y₂O₃ laser rod is placed in a laser cavity and end-pumped. The dopant profile is tailored to be zero at the beginning of the rod, increase along the length of the rod and then decrease at the end of the rod back to zero, as shown in FIG. 6A. The dopant profile in the rod matches the absorption in the rod, when pumped from one end, so that there is a uniform population inversion in the doped portion of the rod, resulting in uniform gain and uniform heat distribution in the active region, as depicted in the plot shown in FIG. 6B. The zero-doped regions at the ends serve to lower the temperature at the ends of the rod to reduce the thermal gradient at the endface/air boundary and increase damage threshold of the laser rod. It should be noted that the layered configuration shown in FIG. 6A is specifically suited for pumping from one end only. However, by slight modification wherein a doped region has highest concentration near the center of the rod, and decreases gradually to zero at each end, it becomes possible to pump from both ends. Suitable materials for such a rod include the five-layer Yb:Y₂O₃ composite material discussed above with reference to FIGS. 5C and 5D, with 0% Yb doping at the ends, 2% Yb doping in the middle, and 1% Yb doped regions sandwiched between the 0% and 2% layers. An advantage of pumping from both ends is that it enables higher laser output powers since the pump power is now doubled.

### Example 3

### Disk Laser

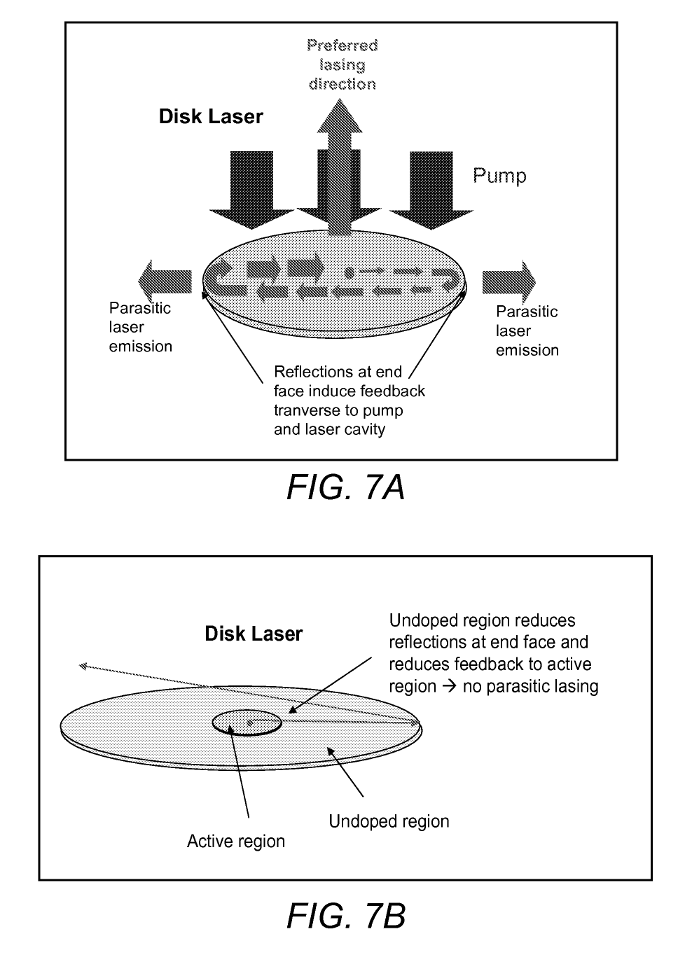

FIGS. 7A and 7B further illustrate aspects of use of a functionally doped laser material according to the present invention. In an exemplary embodiment, a disk laser comprising a highly doped Yb:Y₂O₃ laser medium 1 cm in diameter and 100 μm thick is placed in a laser cavity. In this exemplary embodiment, the laser cavity includes mirrors at each end, a first mirror at a first end being a high reflector of R₁=99.9% reflectivity at λ=1080 nm on one side and a second mirror at the opposite end having R₂=80% reflectivity on the output side. The only losses in the cavity are reflector losses. As shown in FIG. 7A, the laser is pumped perpendicular to the disc and the whole disk is excited uniformly. Based on a simple calculation for lasing threshold, with (R₁R₂)^{γL}≧1 and pumping to achieve a gain of γ=2 cm⁻¹ in the active region, the laser will reach threshold for lasing transverse to the pump direction but not longitudinally in the pump direction, causing parasitic gain. Adding an undoped Y₂O₃ region around the doped disk as shown in FIG. 7B will lower reflections from the interface and extinguish lasing transverse to the pump direction.

### Example 4

### Radial Doping Profile

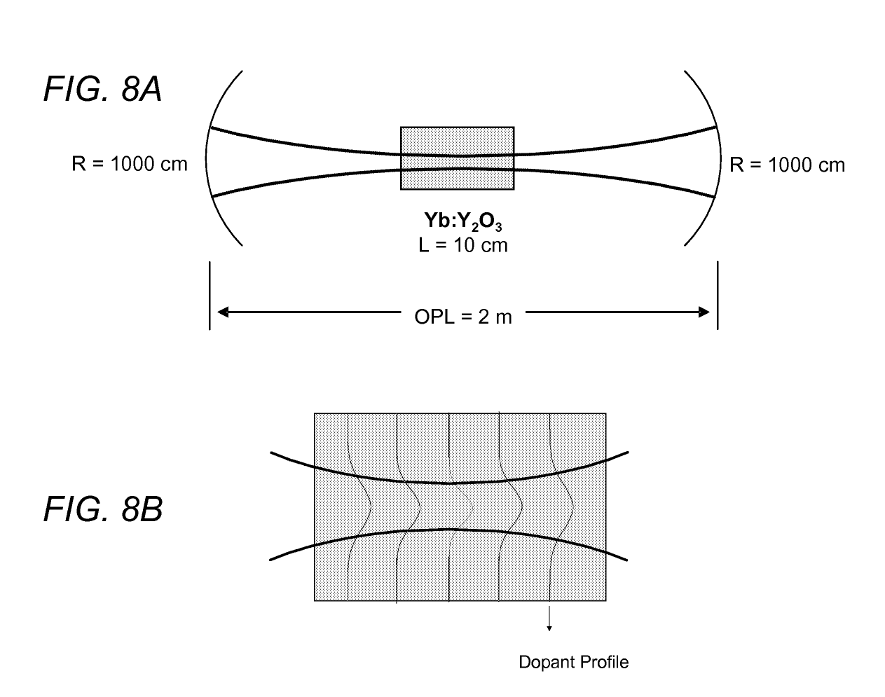

FIGS. 8A and 8B depict aspects of a radial doping profile in a rod-shaped Yb:Y₂O₃ laser medium in accordance with the present invention. In the exemplary configuration shown in FIG. 8A, a Yb:Y₂O₃ rod-shaped medium having a length of 10 cm and a diameter of 5 mm is placed in the center of a laser cavity. The laser cavity has an effective length of 2 meters, and includes two mirrors, each having a radius of curvature 1000 cm. As shown in FIG. 8B. the dopant profile of the rod is radial, with the concentration profile, to first order, matching the spot size of the laser beam at that point. As shown in FIG. 8A, the TEM₀₀ mode of the laser beam produced using the doped laser medium will have a spot size (1/e² point) of ˜0.102 cm in the center of the Yb:Y₂O₃ rod, with the spot size being larger away from the center of the rod, as shown in FIG. 8A. Consequently, as shown in FIG. 8B, the spot size changes with the dopant profile along the laser medium path, having a minimum at the center of the medium and increasing along its length in accordance with the increase in radius of the dopant profile. Thus, in accordance with the present invention the dopant concentration and shape of the profile can be tailored to generate a desired spot size in the laser output

As noted above, it is extremely difficult if not impossible to produce anything other than a uniform doping profile in a single crystal material. It is much easier to produce the graduated doping profiles described herein in polycrystalline ceramic gain material because the material starts out as nano- and/or micro-meter sized particles, which can be densified into solid, transparent laser gain media.

In accordance with the present invention, functionally doped laser gain materials can be fabricated using any one of the methods described below. However, it should be noted that the methods described herein are only exemplary, and materials having features described herein can be fabricated using any suitable method within the scope of the present disclosure.

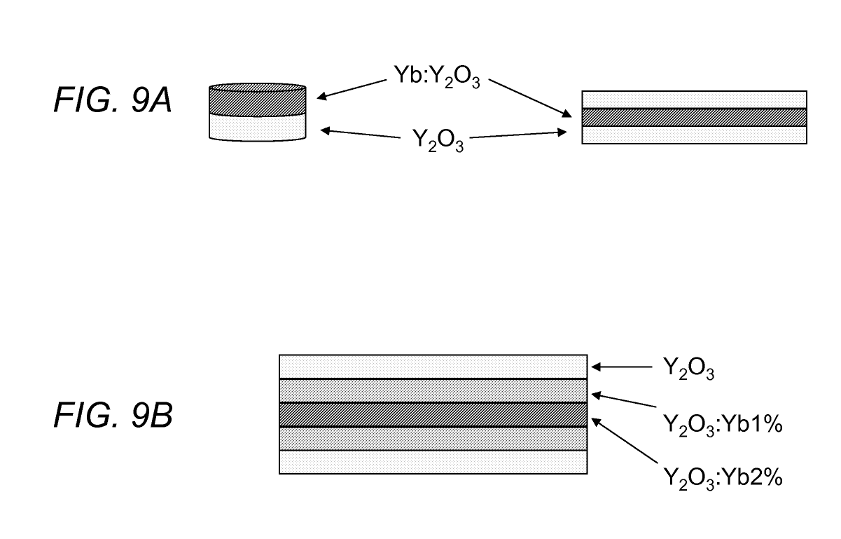

For example, as shown in FIGS. 9A and 9B, a functionally doped laser material in accordance with the present invention can be made from a combination of doped and undoped solid shapes. The exemplary embodiment shown in FIG. 9A depicts a two-level doping profile, with an undoped Y₂O₃ starting material being combined with Yb-doped Y₂O₃. The exemplary embodiment shown in FIG. 9B shows a three-level profile, with a 2% Yb doped central core being flanked by 1% Yb doped material on either side of the 2% Yb material, and undoped Y₂O₃ material surrounding all. In both cases shown in FIGS. 9A and 9B, the solid starting materials can be bonded to each other via diffusion bonding, to form a single solid material having a graded doping profile. Laser materials fabricated in this manner will exhibit a stepped doping profile, with discrete doped areas having well-defined boundaries between doping levels. It is possible to reduce the step size and make more diffuse boundaries by increasing the temperature and time of the bonding process. However, this may lead to increased grain size in the ceramic.

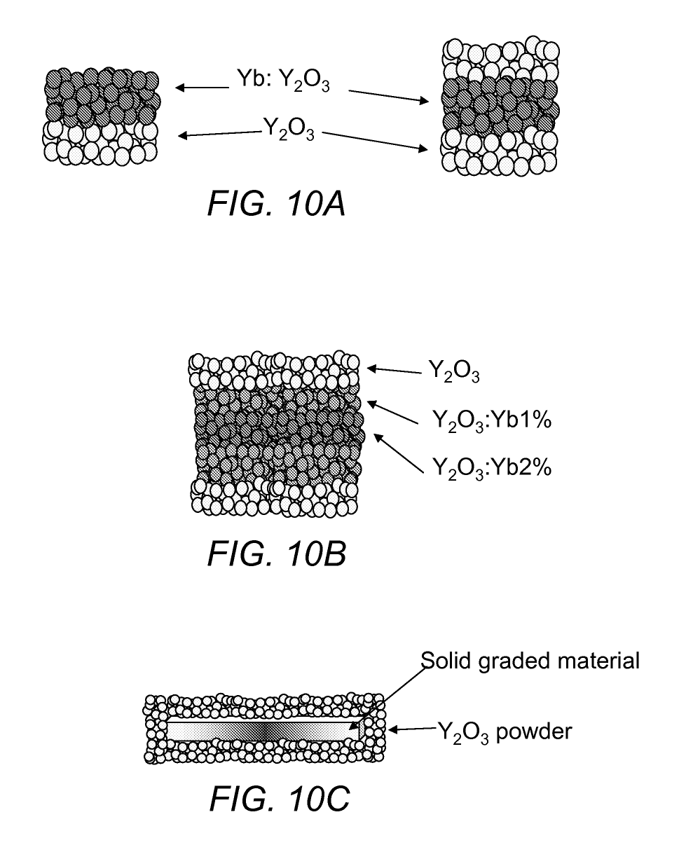

A laser material having a stepped doping profile can also be fabricated using loose ceramic powder or green bodies that are arranged in the desired doping pattern, as shown in FIGS. 10A and 10B. These materials are very similar to those depicted in FIGS. 9A and 9B, except that instead of starting out with solid doped/undoped materials which can be bonded to one another, the materials depicted in FIGS. 10A and 10B are fabricated from loose Yb-doped and undoped Y₂O₃ ceramic powders which can be placed in a mold or otherwise confined to a desired shape. Thus, the exemplary material shown in FIG. 10A can be fabricated from layers of Yb-doped Y₂O₃ and undoped Y₂O₃ powders, in a two-layer (undoped/doped) structure or a three-layer (undoped/doped/undoped) configuration. The exemplary material shown in FIG. 10B can be fabricated from layers of undoped material in combination with doped materials having two or more doping levels, e.g., 2% Yb doped powder in a central core being flanked by 1% Yb doped powder on either side of the 2% Yb material, and undoped Y₂O₃ powder surrounding the 1% doped material. This method can also be employed using green shaped preforms rather than powders as starting materials. The powders (or green shapes as the case may be) can then be formed into a solid material by any suitable method such as pressureless sintering, hot pressing, hot forging, spark plasma sintering, and hot isostatic pressing (HIPing), and their combinations. Yb: Y₂O₃ ceramic materials fabricated from loose powders or green bodies in accordance with these aspects of the present invention can have grain sizes greater than 20 μm, and often in the range of about 50-100 μm. The grain size can also be less than 20 μm.

In addition, as shown in FIG. 10C, in accordance with the present invention, it is possible to make a graded polycrystalline Yb:Y₂O₃ laser material from a combination of solid shapes and powders. In this way, even greater gradations in doping can be achieved.

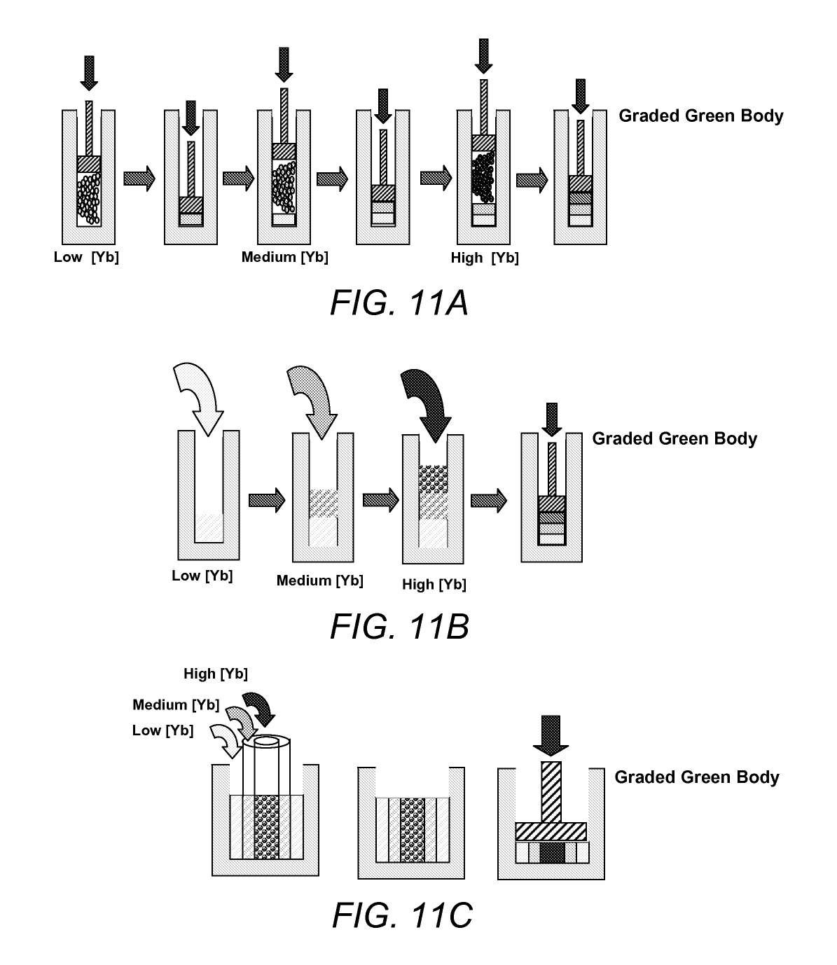

While FIGS. 9A-9B and 10A-10C depict aspects of fabricating doped laser materials having a stepped doping profile, FIGS. 11A to 11C depict exemplary ways of making a linearly graded material in accordance with the present invention.

In a first exemplary method of fabricating a linearly graded material shown in FIG. 11A, the graded material is fabricated by forming individual green bodies each having a desired doping level from loose Yb:Y₂O₃ powder. Thus, as shown in FIG. 11A, a first portion of Yb:Y₂O₃ powder having a low (or zero) Yb concentration can be placed in a die and formed into a green body by any conventional method such as dry pressing, casting, gel casting, cold isostatic pressure (CIP), or doctor blading. Next, a second portion of Yb:Y₂O₃ powder having a medium Yb concentration can be placed on top of the green body formed from the first Yb:Y₂O₃ powder and a second green body be formed therefrom. A third portion of Yb:Y₂O₃ powder having a high Yb concentration can then be placed in the die on top of the second green body and a third green body can be formed. This process can be repeated in any desired order to build more layers.

In a second exemplary method shown in FIG. 11B, instead of sequentially forming a green body from each individual layer of Yb-doped loose powder, multiple layers of Yb-doped powder having the desired doping levels can be placed in the die, and a single green body is formed therefrom. Thus, as shown in FIG. 11B, a first portion of Yb:Y₂O₃ powder having a low (or zero) Yb concentration can be placed in a die, followed by a second portion of Yb:Y₂O₃ powder having a medium Yb concentration and a third portion of Yb:Y₂O₃ powder having a high Yb concentration. Once all the desired Yb-doped powders having the desired doping levels are placed in the die, a single green body can be formed. Obviously, more powder layers than those shown FIG. 11B and/or different combinations thereof can be used to form the green body.

FIG. 11C depicts a method similar to that depicted in FIG. 11B, but in a radial configuration rather than a linear one to produce a disk-shaped material (or rod). As shown in FIG. 11C, open ended cylinders can be concentrically placed into the die. Yb-doped loose powder having different dopant levels can then be placed within each of the cylinders to create a graded profile, with the number and difference in diameter of the cylinders determining the doping gradient of the material. Thus, a first portion of Yb:Y₂O₃ powder having a high Yb concentration can be placed in a first cylinder at the center of the die, a second portion of Yb:Y₂O₃ powder having a medium Yb concentration can be placed in second cylinder adjacent to the central cylinder, and a third portion of Yb:Y₂O₃ powder having a low (or zero) Yb concentration can be placed in an outer cylinder. Once all of the powders have been placed in the die, the cylinders can be removed and the loose powder pressed into a green body.

The green bodies formed by any of these methods can then be densified into a final material by techniques such as pressureless sintering, hot pressing, hot forging, spark plasma sintering, and hot isostatic pressing (HIPing), and their combinations.

To make a material that is graded both radially and linearly, a combination of the methods shown in FIGS. 11B and 11C can be used. If a profile other than radial is required, hollow tubes having non-circular cross sections can be used.

In addition, the methods described with respect to FIGS. 11B and 11C, where the green body is not formed until all of the loose Yb-doped powders are placed in the die, can be used if a more continuous grading profile is desired, as the loose powders can more readily intermingle between layers as they are being pressed into the green body. In contrast, the method described with respect to FIG. 11A, where each individual layer of powder is pressed into a green body as it is being added, can be used if a gradient profile having more discrete doping levels is desired. Of course, if a still more discrete doping profile is desired, the methods described above with respect to FIGS. 9A and 9B can be used, where already pressed green bodies are stacked into the desired doping pattern.

Regardless of the method used, a graded doped material produced in accordance with these methods can have a grain size greater than 20 μm or smaller than 20 μm

The thus-prepared three-layer green bodies can then be formed into a final solid graded material by any suitable method, or combination thereof, including the pressureless sintering, hot pressing, hot forging, spark plasma sintering, and hot isostatic pressing (HIPing) methods described above as well as combinations thereof.

Methods for making a functionally doped polycrystalline ceramic laser material in accordance with the present invention are illustrated by the following Examples 5-10.

### Example 5

### Diffusion Bonded Solids Producing a Step Gradient

Doped and undoped solid shapes (based on Yb doped yttria and undoped yttria) were machined and polished to provide a relatively smooth interface. The solid shapes were loaded in a hot press die and heated to 1500° C. at 5,000 psi for 2 hours. The resulting solid shape results in a laser gain medium with a stepwise gradient. The number and size of the steps, as well as the profile, are determined by the number of solid shapes used and dopant levels of the solid shapes.

### Example 6

### Diffusion Bonded Solids Producing a Functional Gradient

The material of Example 5 was held in the hot press at 1500° C. longer than 2 hours (could be up to 24 hours). Another sample was heated in the hot press to a temperature higher than 1500° C. but less than the melting temperature of 2400° C. Another sample was post annealed in a separate furnace for 1 hour (could be up to 48 hours) between 1500° C. and the melting point. The extended times and temperatures enable diffusion of the dopant material which smoothes out the step-like dopant profile.

### Example 7

### Step Gradient from Loose Powder

Powders of varying Yb concentration were packed into a green body in a dry pressing die as shown in FIG. 11B and then loaded in the hot press Powders of varying Yb concentration were then directly loaded into the hot press die on top of the pressed powders. The graded compacts were heated to 1500° C. for 2 hours in vacuum hot press at 5,000 psi to form dense, transparent ceramic laser materials with a step gradient.

### Example 8

### Functionally Graded Ceramic from Loose Powder

The procedure is similar to Example 7. The powder is loaded into the hot press in the same manner as in Example 3. This time the powders were hot pressed at temperatures of 1500° C. for more than 2 hours (could be up to 12 hours). The temperature could also be higher but must remain below the melting temperature of 2400° C. The material can be subsequently heat treated between 1400° C. and a temperature below the melting point for 1-48 hours to further diffuse the dopant. The extended times and temperatures enable diffusion of the dopant material which smoothes out the step-like dopant profile.

### Example 9

### Step or Functionally Graded from Green Shapes

Loose powders were formed into green shapes of varying Yb concentration. The green shapes were loaded into a hot press die with a desired dopant profile. The material was processed as in Example 7 to create a step profile and as in Example 8 to create a functionally graded profile.

### Example 10

### Cladded Graded Material

The material from any and all of the previous Examples was surrounded by undoped powder and hot pressed at 1500° C. for 2 hours at 5,000 psi. This formed a graded material surrounded by undoped yttria.

### Advantages and New Features

Thus, as described herein, a functionally doped polycrystalline ceramic material can be formed which can improve laser performance over uniformly doped materials.

These composite structures can have many commercial and military applications. The doped structures could be used in existing fielded lasers to improve beam quality in these systems without replacing the system, and could also be used to improve beam quality in unstable resonators and gain guide in these resonators as well as others for improved laser performance.

For example, the composite rod structures described herein can provide improved beam quality and higher power laser output. The structures could also be applicable in ceramic fiber form, which can enable improved thermal management due to the high aspect ratio and enable higher laser output powers.

Alternatively, the profile can be tailored such that a radial or transverse thermal gradient can be established in the laser medium. The thermal gradient can be used to tailor the mode of the laser beam and guide the beam, or correct for beam distortions of a seed beam in a master oscillator, power amplifier (MOPA) geometry.

In addition, functionally doped polycrystalline ceramic laser media in accordance with the invention can allow reduction of parasitic effects in lasers to increase efficiency and power output, and can be used to reduce trapped fluorescence in radiation-balanced laser systems which can result in heating of the laser media.

Although particular embodiments, aspects, and features have been described and illustrated, it should be noted that the invention described herein is not limited to only the described embodiments, aspects, and features, as it can be readily appreciated that modifications thereto may be made by persons skilled in the art. The present application contemplates any and all such modifications within the spirit and scope of the underlying invention described and claimed herein, and such embodiments are within the scope of the present disclosure.

What is claimed is:

1. A method for making a functionally doped polycrystalline ceramic laser medium, comprising:
placing a first doped polycrystalline ceramic material having a first dopant concentration in a die;
placing a second doped solid polycrystalline ceramic materials having a second dopant concentration adjacent the first doped polycrystalline ceramic material, the second dopant concentration being different from the first dopant concentration, at least one of the first and second doped polycrystalline ceramic materials being a solid ceramic material; and
bonding the first doped polycrystalline ceramic material to the second doped polycrystalline ceramic material to form a single solid material comprising a first doped region and a second doped region, wherein at least one of the first and second doped regions have an average grain size of ≧20 μm, and wherein the first and second doped regions have a stepped doping gradient from the first dopant concentration to the second dopant concentration

2. The method for making a functionally doped polycrystalline ceramic laser medium according to claim 1, further comprising bonding the first doped polycrystalline ceramic material to the second doped polycrystalline ceramic material by at least one of diffusion bonding, hot pressing, and pressureless sintering.

3. The method for making a functionally doped polycrystalline ceramic laser medium according to claim 1, wherein the second dopant concentration is greater than the first dopant concentration.

4. The method for making a functionally doped polycrystalline ceramic laser medium according to claim 1, wherein at least one of the first and second dopants comprises rare earth ions.

5. The method for making a functionally doped polycrystalline ceramic laser medium according to claim 1, wherein at least one of the first and second dopants comprises transition metal ions.

6. The method for making a functionally doped polycrystalline ceramic laser medium according to claim 1, wherein at least one of the first and second dopants is ytterbium (Yb).

7. The method for making a functionally doped polycrystalline ceramic laser medium according to claim 1, wherein at least one of the first and second doped polycrystalline ceramic materials comprises Yb-doped yttria (Yb:Y₂O₃).

8. The method for making a functionally doped polycrystalline ceramic laser medium according to claim 1, wherein at least one of the first and second doped polycrystalline ceramic materials comprises Yb-doped scandia (Yb:Sc₂O₃).

9. The method for making a functionally doped polycrystalline ceramic laser medium according to claim 1, wherein at least one of the first and second doped polycrystalline ceramic materials comprises a solid ceramic fabricated from nano-sized particles.

10. The method for making a functionally doped polycrystalline ceramic laser medium according to claim 1, wherein at least one of the first and second doped polycrystalline ceramic materials comprises a solid ceramic fabricated from micron-sized particles.

11. The method for making a functionally doped polycrystalline ceramic laser medium according to claim 1, wherein the first doped polycrystalline material comprises a solid ceramic and the second doped polycrystalline ceramic materials comprises a green body ceramic.

12. The method for making a functionally doped polycrystalline ceramic laser medium according to claim 1, wherein the first doped polycrystalline material comprises a solid ceramic and the second doped polycrystalline ceramic materials comprises a doped ceramic powder.

13. A method for making a functionally doped polycrystalline ceramic laser medium, comprising:
placing a first doped polycrystalline ceramic material having a first dopant concentration in a die;
placing a second doped solid polycrystalline ceramic material having a second dopant concentration adjacent the first doped polycrystalline ceramic material, the second dopant concentration being different from the first dopant concentration, at least one of the first and second doped polycrystalline ceramic materials being a green body ceramic; and
bonding the first doped polycrystalline ceramic material to the second doped polycrystalline ceramic material to form a single solid material comprising a first doped region and a second doped region, wherein at least one of the first and second doped regions have an average grain size of ≧20 μm, and wherein the first and second doped regions have a linear doping profile in the form of a continuous gradient from the first dopant concentration to the second dopant concentration.

14. The method for making a functionally doped polycrystalline ceramic laser medium according to claim 13, further comprising bonding the first doped polycrystalline ceramic material to the second doped polycrystalline ceramic material by at least one of diffusion bonding, pressureless sintering, hot pressing, hot forging, spark plasma sintering, and hot isostatic pressing, or their combinations.

15. The method for making a functionally doped polycrystalline ceramic laser medium according to claim 13, wherein the second dopant concentration is greater than the first dopant concentration such that the doped polycrystalline laser medium has a continuously increasing dopant concentration from the first doped region to the second doped region.

16. The method for making a functionally doped polycrystalline ceramic laser medium according to claim 13, wherein at least one of the first and second dopants comprises rare earth ions.

17. The method for making a functionally doped polycrystalline ceramic laser medium according to claim 13, wherein at least one of the first and second dopants comprises transition metal ions.

18. The method for making a functionally doped polycrystalline ceramic medium according to claim 13, wherein the at least one of the first and second dopants is ytterbium (Yb).

19. The method for making a functionally doped polycrystalline ceramic laser medium according to claim 13, wherein at least one of the first and second doped polycrystalline ceramic materials comprises Yb-doped yttria (Yb:Y₂O₃).

20. The method for making a functionally doped polycrystalline ceramic laser medium according to claim 13, wherein at least one of the first and second doped polycrystalline ceramic materials comprises Yb-doped scandia (Yb:Sc₂O₃).

21. The method for making a functionally doped polycrystalline ceramic laser medium according to claim 13, wherein at least one of the first and second doped polycrystalline ceramic materials comprises a green body ceramic fabricated from nano-sized particles.

22. The method for making a functionally doped polycrystalline ceramic laser medium according to claim 13, wherein at least one of the first and second doped polycrystalline ceramic materials comprises a green body ceramic fabricated from micron-sized particles.

23. The method for making a functionally doped polycrystalline ceramic laser medium according to claim 13, wherein the first doped polycrystalline material comprises a green body ceramic and the second doped polycrystalline ceramic material comprises a doped ceramic powder.

24. The method for making a functionally doped polycrystalline ceramic laser medium according to claim 23, wherein the doped ceramic powder comprises nano-sized particles.

25. The method for making a functionally doped polycrystalline ceramic laser medium according to claim 23, wherein the doped ceramic powder comprises micron-sized particles.

26. A method for making a functionally doped polycrystalline ceramic laser medium, comprising:
placing a first doped polycrystalline ceramic material having a first dopant concentration in a die;
placing a second doped solid polycrystalline ceramic material having a second dopant concentration into the die adjacent the first doped polycrystalline ceramic material, the second dopant concentration being different from the first dopant concentration, at least one of the first and second doped polycrystalline ceramic materials comprising loose polycrystalline ceramic powders; and
bonding the first doped polycrystalline ceramic material to the second doped polycrystalline ceramic material to form a single solid material comprising a first doped region and a second doped region, wherein at least one of the first and second doped regions have an average grain size of ≧20 μm, and wherein the first and second doped regions have a linear doping profile in the form of a continuous gradient from the first dopant concentration to the second dopant concentration.

27. The method for making a functionally doped polycrystalline ceramic laser medium according to claim 26, further comprising bonding the first doped polycrystalline ceramic material to the second doped polycrystalline ceramic material by at least one of diffusion bonding, pressureless sintering, hot pressing, hot forging, spark plasma sintering, and hot isostatic pressing.

28. The method for making a functionally doped polycrystalline ceramic laser medium according to claim 26, wherein the second dopant concentration is greater than the first dopant concentration such that the doped polycrystalline laser medium has a continuously increasing dopant concentration from the first doped region to the second doped region.

29. The method for making a functionally doped polycrystalline ceramic laser medium according to claim 26, wherein at least one of the first and second dopants comprises rare earth ions.

30. The method for making a functionally doped polycrystalline ceramic laser medium according to claim 26, wherein at least one of the first and second dopants comprises transition metal ions.

31. The method for making a functionally doped polycrystalline ceramic medium according to claim 26, wherein the at least one of the first and second dopants is ytterbium (Yb).

32. The method for making a functionally doped polycrystalline ceramic laser medium according to claim 26, wherein at least one of the first and second doped polycrystalline ceramic materials comprises Yb-doped yttria (Yb:Y₂O₃).

33. The method for making a functionally doped polycrystalline ceramic laser medium according to claim 26, wherein at least one of the first and second doped polycrystalline ceramic materials comprises Yb-doped scandia (Yb:Sc₂O₃).

34. The method for making a functionally doped polycrystalline ceramic laser medium according to claim 26, wherein at least one of the first and second doped polycrystalline ceramic materials comprises nano-sized particles.

35. The method for making a functionally doped polycrystalline ceramic laser medium according to claim 26, wherein at least one of the first and second doped polycrystalline ceramic materials comprises micron-sized particles.
